(19) United States
(12) Patent Application Publication
(10) Pub. No.: US 2009/0136255 A1
(43) Pub. Date: May 28, 2009

(54) IMAGE FORMING APPARATUS

(75) Inventor: Noriyuki TAKUWA, Kawasaki-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/277,117

(22) Filed: Nov. 24, 2008

Related U.S. Application Data
(60) Provisional application No. 60/990,092, filed on Nov. 26, 2007.

(51) Int. Cl. G03G 15/00

(52) U.S. Cl. 399/107

(57) ABSTRACT

According to an embodiment of the present invention, there is provided an image forming apparatus including an image forming unit that outputs an image corresponding to image data to an output medium and a load bearing supporting structure that is connected to the image forming unit and can provide strength in a vertical direction when the image forming unit is housed in a housing member. The load bearing supporting structure houses therein a harness connectable to an operation unit that can input a control signal to the image forming unit.

### CROSS-REFERENCE TO RELATED APPLICATION

This application is based upon and claims the benefit of priority from: U.S. Provisional Application No. 60/990,092 filed on Nov. 26, 2007, the entire contents of each of which are incorporated herein reference.

### TECHNICAL FIELD

The present invention relates to an image forming apparatus that can obtain a sheet-like medium, i.e., hard copy or print out on which a copied image or document of an object is outputted.

### BACKGROUND

As image forming apparatuses that can use, as a recording material (a sheet material), general plain paper not specially processed, image forming apparatuses employing various systems such as an electrophotographic system, an ink-jet system, and a thermal transfer system are already wide spread. The image forming apparatuses are imparted with multiple functions according to diversification of requests from users. Nowadays, the image forming apparatuses are called multi-functional peripherals (MFPs).

An MFP includes an operation unit used for, for example, inputting the number of times of image formation (the number of outputs) and control information.

The operation unit is located in, as disclosed in JP-A-2000-19804, for example, an arbitrary position of a supporting mechanism represented by a stay or a swing arm set connected to the back or the side of the MFP.

However, the supporting mechanism that supports the operation unit or the operation unit integrated with the supporting mechanism needs to be packed independently from an MFP main body (packed in a state removed from the MFP main body) in protection, i.e., packing for transporting the MFP. The operation unit may be separately packed.

Therefore, when the MFP is set up, work for assembling the operation unit is necessary. It may be requested to draw around a harness member connected to the operation unit and set (house) the operation unit in a predetermined housing structure.

On the other hand, when the MFP is packed in a state in which the operation unit and the supporting mechanism are integrated with the MFP, an amount of packing materials required for packing and the size (volume) of the packed MFP increase. A special (packing) material may be required for packing the operation unit and the supporting mechanism.

### SUMMARY

It is an object of the present invention to provide a packing method for reducing the volume in packing (after packing) an MFP including an operation unit connected to the MFP through a stay or a swing arm set.

It is another object of the present invention to provide a packing method that can reduce work time required in setting up the MFP.

It is still another object of the present invention to provide a packing method that can increase the strength after packing (stacking safety) when the MFP is packed.

The present invention provides an image forming apparatus including: an image forming unit that outputs an image corresponding to image data to an output medium; and a load bearing supporting structure that is connected to the image forming unit and can provide strength in a vertical direction when the image forming unit is housed in a housing member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are diagrams of an example of a multi-functional peripheral (MFP) according to an embodiment of the present invention;

FIG. 2 is a diagram of an example in which a packing member for transporting the MFP shown in FIGS. 1A and 1B supports the MFP;

FIG. 3 is a diagram of an example of the structure of a column of the MFP shown in FIGS. 1A and 1B;

FIG. 4 is a diagram of an example of the structure of a column of the MFP shown in FIGS. 1A and 1B; and

FIG. 5 is a diagram of another example in which the packing member for transporting the MFP shown in FIGS. 1A and 1B supports the MFP.

### DETAILED DESCRIPTION

An example of an embodiment according to the invention will be described below in detail with reference to the drawings.

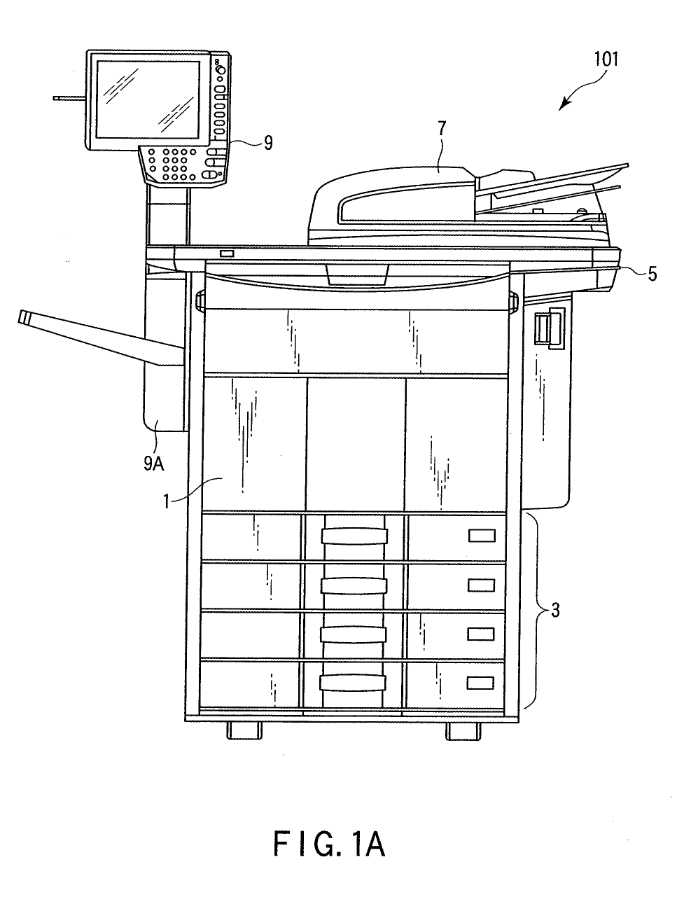

FIGS. 1A and 1B are schematic diagrams of an image forming apparatus (a multi-functional peripheral; MFP) according to the embodiment of the present invention.

An image forming apparatus 101 shown in FIGS. 1A and 1B includes an image forming unit main body 1 that forms an image output called, for example, hard copy or print out from image information, a sheet feeding unit 3 that feeds a sheet (an output medium) of an arbitrary size used for the image output to the image forming unit main body 1, and an image scanning unit 5 that captures, as shading of light, an object subjected to image formation in the image forming unit main body 1, i.e., image information and outputs image data. Although not explained in detail, the image scanning unit 5 includes a not-shown original table, for example, a transparent glass that supports an object, and an image sensor, for example, a CCD sensor that converts the image information into image data. The image scanning unit 5 converts, using the CCD sensor, image information of the object into image data and outputs the image data.

When an original is sheet-like, an auto document feeder (ADF) 7 that discharges, after an image output is formed or image information is captured (hereinafter referred to as scanning), the original subjected to the scanning from a scanning position to a discharge position and guides the next original to the scanning position is connected to the image scanning unit 5.

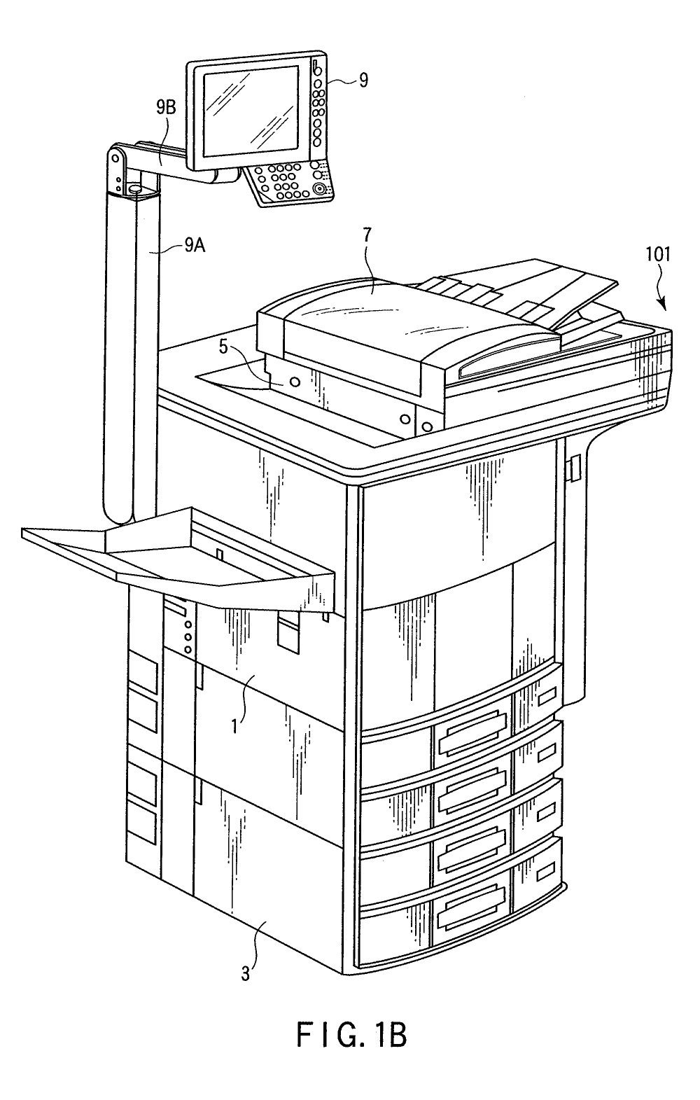

An instruction input unit, i.e., a control panel (an operation unit) 9 for instructing the start of image formation in the image forming unit main body 1 and the start of scanning of image information of an original by the image scanning unit 5 is located in a predetermined position of the image forming apparatus 101, for example, a corner on the left side or the right side behind the image scanning unit 5 (see FIG. 2).

The operation unit 9 is provided in a swing arm 9B located in a column 9A fixed substantially in parallel to the vertical direction in the image forming unit main body 1.

The column 9A has height substantially the same as that of a component located in the highest position among components of the ADF 7 (see FIG. 2). The height of the column 9A may be a separation position for removing the swing arm 9B. When the swing arm 9B is integrated with the column 9A, the height of the column 9A is the highest position of the swing arm 9A.

The column 9A is directly connected to the image forming unit main body 1. The column 9A extends to at least a predetermined position of the image forming unit main body 1. The column 9A has arbitrary length in a range of the total height of the image forming apparatus 101.

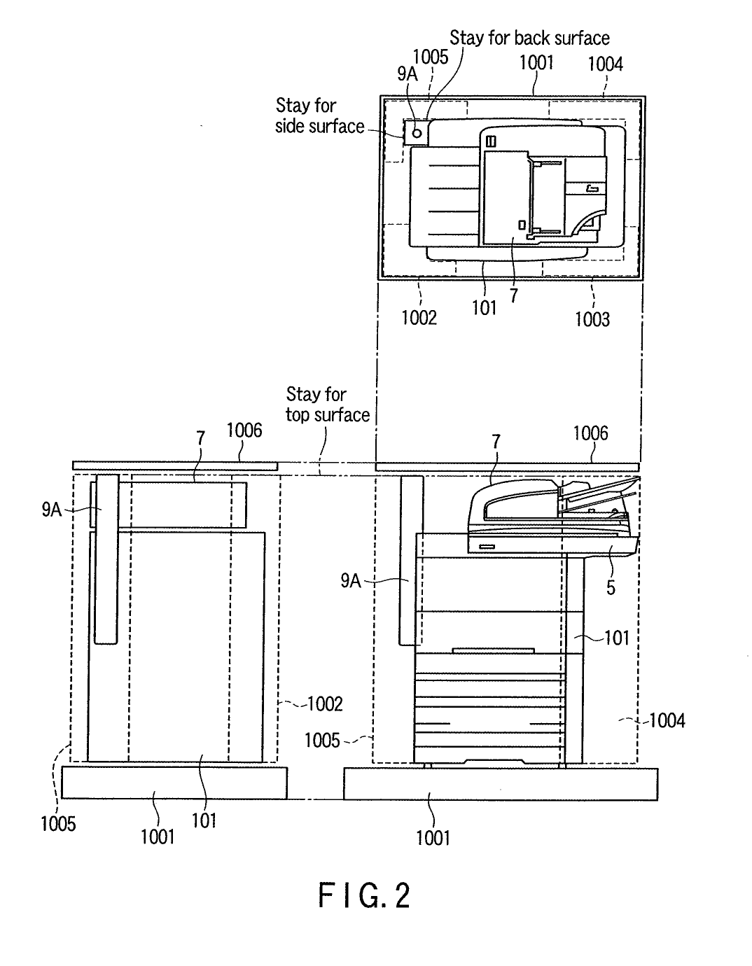

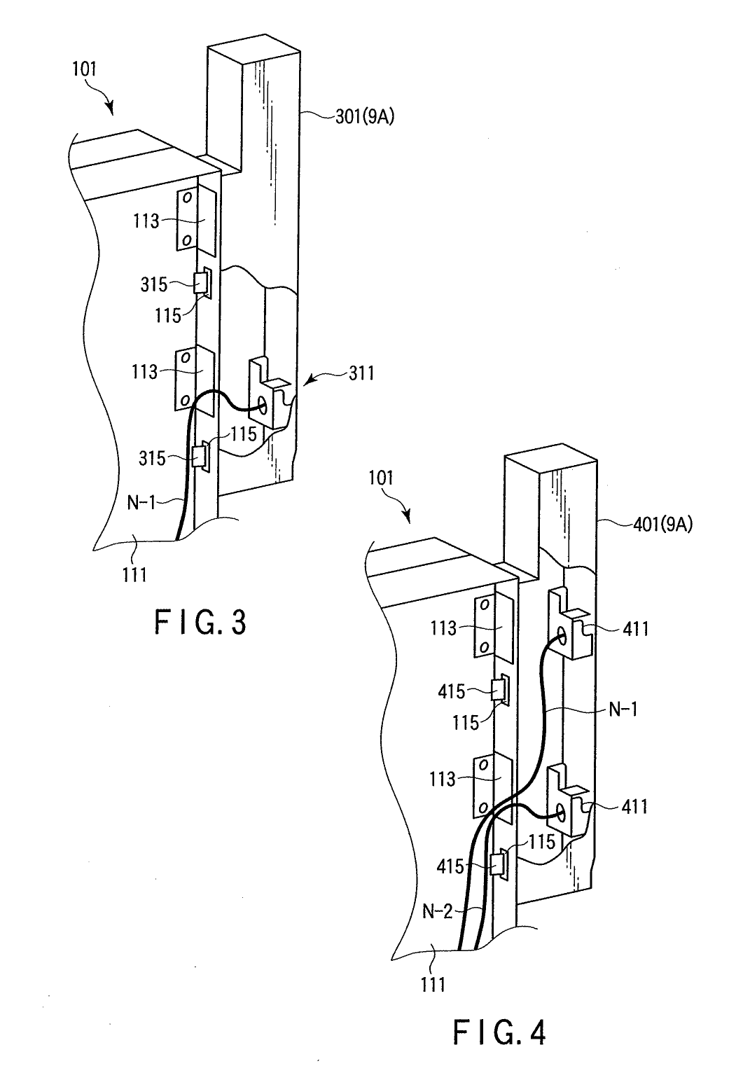

As shown in FIG. 3 or 4 as an example, the column 9A allows a signal line group connecting the operation unit 9, the image forming unit main body 1, the sheet feeding unit 3, the image scanning unit 5, and the ADF 7 to one another, i.e., a not-shown harness to pass through the inside of the column 9A. In other words, the harness is guided through the column 9A. The column 9A includes a space through which the harness can pass. The space of the column 9A can be secured by, for example, forming the column 9A in a hollow shape (a pipe shape). The column 9A may adopt, as long as the space can be provided, various shapes such as a shape formed by removing a part of the hollow and the structure in which a part of the hollow is opened. In other words, the column 9A is not limited by the use of a pipe-like base material and may adopt various shapes formed by bending or cutting out the base material.

For example, as shown in FIG. 3, projections 315, which are parts of a column 301 (9A), are integrated with plural openings 113 and plural slit-like holes (slim openings) 115 of a chassis 111 of the image forming apparatus 101. As a result, the column 301 (9A) is firmly connected to the image forming apparatus 101.

The openings 113 allow arbitrary harnesses to pass through the openings 113. Although not shown in the figure, edge portions of the openings 113 and 115 include protection members to prevent the harnesses from being damaged. The harnesses may include tubes or protection materials formed in a spiral shape.

The column 301 (9A) has a connector holder 311 in a lower part in the height direction. For example, although not explained in detail, a harness N-1 having a connector prepared in advance therein is located in the connector holder 311 (the harness N-1 is connected to the connector holder 311).

The column 301 (9A) has a hollow shape and a sectional shape thereof has four sides or has five or more sides. Alternatively, the column 301 (9A) has a circular or elliptical section or a section of an arbitrary shape formed by a continuous free curved surface. A section of the column 301 (9A) may be discontinuous at least in a part thereof.

FIG. 4 is a diagram of another example of the harness housing structure (column) different from the example shown in FIG. 3.

At least one of the slits 115 of the chassis 111 of the image forming apparatus 101 receives a projection 415, which is a part of a column 401 (9A).

The column 401 (9A) is integrated with the chassis 111 by using the projection 415 (the projection 415 is combined with the slit 115).

The column 401 (9A) has, in two places apart from each other in the height direction, connection terminals (connector holders) 411 that are provided in harnesses of an accessory device and to which the harnesses can be connected. For example, although not explained in detail, a harness N-1 having a connector prepared in advance therein is located in one connector holders 411 and a harness N-2 for not-shown another accessory device is located in the other connector holder 411 (the harnesses N-1 and N-2 are connected to the connector holders 411).

The structure shown in FIG. 3 or 4 makes it possible to prepare harnesses in advance in the column. Therefore, when the image forming apparatus 101 is set up, it is possible to connect the operation panel 9 to the image forming apparatus 101 simply by, for example, connecting the operation panel 9 (the swing arm 9B), which is separately packed, to the column 9A and attaching a not-shown connector or the like.

FIG. 2 is a diagram of an example of packing used in transporting the image forming apparatus 101.

The image forming apparatus 101 (a finished product) is placed in a predetermined position of a base packing member 1001.

The base packing member 1001 supports the image forming apparatus 101 in four places in conjunction with first to fourth vertical packing materials 1002 to 1005.

The fourth vertical packing material 1005 supports the column 9A from two directions. One direction is a back direction of the image forming apparatus 101. In the direction, the fourth vertical packing material 1005 gives substantially the same pressure to the image forming apparatus 101 and the column 9A (the packing material 1005 supports the back of the image forming apparatus 101 and a surface on the back side of the column 9A). The other direction is a side direction of the image forming apparatus 101. In the direction, the packing material 1005 gives predetermined pressure to the column 9A connected to the image forming apparatus 101 (the packing material 1005 supports a surface on a side in contact with the side of the column 9A located on the left side of the image forming apparatus 101).

The fourth packing material 1005 has height enough for protecting the highest portion of the ADF 7, which is integrated with the image forming apparatus 101, in conjunction with the first to third packing materials 1002 to 1004. The height enough for protecting the highest portion of the ADF 7 is at least substantially equal to the height of the top of the column 9A or substantially equal to separation height (a separation position) for removing the swing arm 9B.

Therefore, an upper packing material 1006 is supported by protection force in the vertical direction generated by the column 9A (and the chassis 111) in addition to protection force (load bearing force) in the vertical direction generated by the first to fourth packing materials 1002 to 1005. This makes it possible to reduce the pressure in the vertical direction applied to the ADF 7.

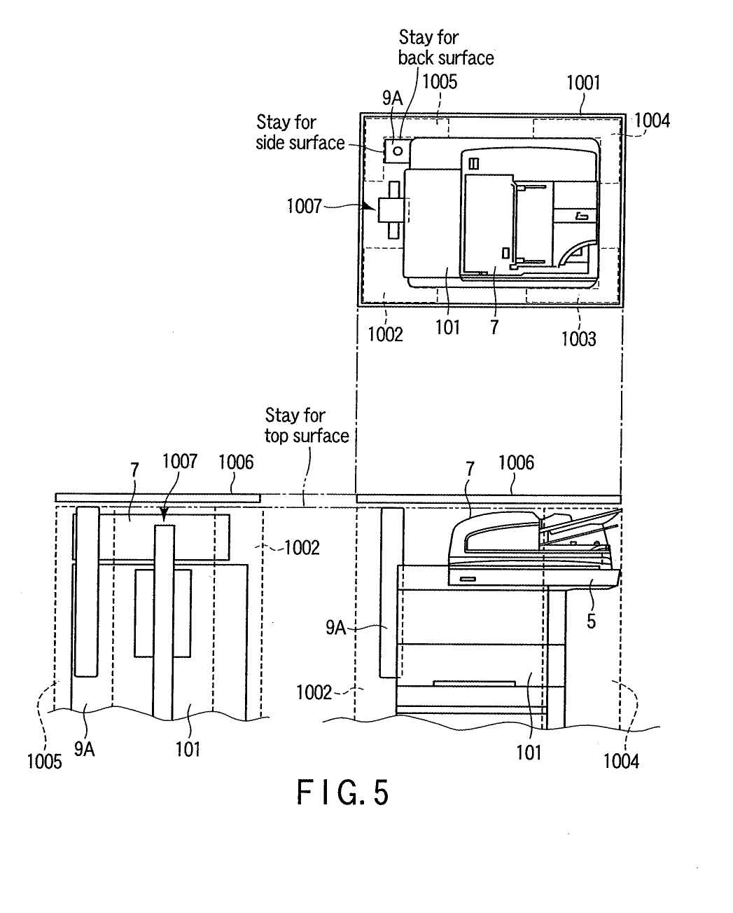

FIG. 5 is a diagram of another example of packing different from that shown in FIG. 2.

For example, the operation panel 9 and the swing arm 9B are packed independently from the image forming apparatus 101 in which the column 9A is connected to the image forming unit main body 1. In this case, the operation panel 9 and the swing arm 9B are housed in a parts box 1007 and simultaneously packed in the pack shown in FIG. 2. The parts box 1007 is located in a predetermined position in a space defined by the base packing member 1001, the first to fourth vertical packing materials 1002 to 1005, and the upper packing material 1006.

In the example shown in FIG. 5, the swing arm 9A and the operation panel 9, which are integrally packed, can be packed in a space of a pack of the main body. Therefore, the size of the pack can be reduced.

As explained above, in the image forming apparatus according to this embodiment, since the height of an upper surface of the column is set at substantially the same height as the accessory device, the impact received by only the accessory device in packing on the upper surface in the past is received by the column as well. The column is firmly attached to a frame of the image forming unit main body. Therefore, it is possible to increase the strength against the impact on the upper surface.

Since the impact on the back (a rear surface) received by a rear cover in the past is received by the column as well, the column itself has a firm shape. Therefore, it is possible to increase the strength against the impact on the back.

Moreover, the image forming apparatus and the accessory device according to the present invention make it easy to connect a harness and a connecting element integrated with the accessory device and the image forming unit main body and check a result of the connection.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image forming unit that outputs an image corresponding to image data to an output medium; and
a load bearing supporting structure that is connected to the image forming unit and can provide strength in a vertical direction when the image forming unit is housed in a housing member.

2. The apparatus of claim 1, wherein the load bearing supporting structure houses a harness therein.

3. The apparatus of claim 1, further comprising:
an operation unit that can input a control signal to the image forming unit.

4. The apparatus of claim 3, wherein the operation unit is integrated with the load bearing supporting structure.

5. The apparatus of claim 3, wherein the load bearing supporting structure houses a harness connected to the operation unit therein.

6. The apparatus of claim 1, further comprising:
an accessory device that feeds an object having image information, which is an image forming object, to the image forming unit.

7. The apparatus of claim 6, further comprising:
an operation unit that can input a control signal to the image forming unit.

8. The apparatus of claim 7, wherein the load bearing supporting structure houses a harness connected to the operation unit therein.

9. The apparatus of claim 8, wherein the operation unit is integrated with the load bearing supporting structure.

10. The apparatus of claim 8, wherein the load bearing supporting structure has height substantially the same as height of the accessory device.

11. A method of housing an image forming apparatus, comprising:
placing the image forming apparatus having a supporting member, which provides load bearing force, on a base holding member; and
setting first to fourth vertical supporting members surrounding the image forming apparatus on the base holding member, at least one of the vertical supporting members being set in contact with the supporting member.

12. The method of claim 11, wherein the supporting member has height substantially equal to height of an accessory device integrated with the image forming apparatus.

13. The method of claim 11, wherein the supporting member includes a harness connected to a harness of an input device that can supply a control signal to the image forming apparatus.

14. The method of claim 12, wherein the supporting members includes a harness connected to a harness of an input device that can supply a control signal to the image forming apparatus.

15. The method of claim 13, wherein the supporting member has height substantially equal to height of an accessory device integrated with the image forming apparatus.

16. An image forming apparatus comprising:
means for forming an output image; and
means for providing load bearing force.

17. The apparatus of claim 16, wherein the providing means houses a harness therein.

18. The apparatus of claim 16, further comprising:
means for inputting a control signal for actuating the image forming unit.

19. The apparatus of claim 18, wherein the providing means houses a harness connected to the inputting means therein.

20. The apparatus according to claim 16, further comprising:
means for feeding an object having image information, which is an image forming object, to the forming means.
